(19) United States
(12) Patent Application Publication
(10) Pub. No.: US 2025/0216549 A1
(43) Pub. Date: Jul. 3, 2025

(54) LASER-RANGING DEVICE AND LASER-RANGING TELESCOPE

(71) Applicant: SHENZHEN RUIERXING ELECTRONIC CO., LTD, Shenzhen (CN)

(72) Inventors: Luxin Fu, Shenzhen (CN); Zhicheng Xing, Shenzhen (CN)

(21) Appl. No.: 18/741,716

(22) Filed: Jun. 12, 2024

(30) Foreign Application Priority Data
Jan. 2, 2024 (CN) 202410007100.0

(51) Int. Cl. G01S 17/08; G01S 7/481; G01S 17/88; G02B 23/04

(52) U.S. Cl. CPC G01S 17/08; G01S 7/4811; G01S 17/88; G02B 23/04

(57) ABSTRACT

A laser-ranging device is attachable to a complete telescope as an independent component. The telescope includes first and second telescope bodies, and the laser-ranging device includes first and second barrels deposed in front of objective lenses of the first and second telescope bodies, respectively. Central axes of the first and second barrels align with those of the first and second telescope bodies, respectively. An interior of the first barrel is provided with a laser transmitter for emitting laser, a first concave mirror for converging and reflecting the laser, and a first dichroic mirror for reflecting the laser and transmitting natural light. An interior of the second barrel is provided with a laser receiver for receiving the laser, a second concave mirror for converging and reflecting the laser, and a second dichroic mirror for reflecting the laser and transmitting the natural light.

### CROSS-REFERENCE TO RELATED APPLICATIONS

The present disclosure claims priority of Chinese Patent disclosure No.202410007100.0, filed on Jan. 2, 2024, the entire contents of which are hereby incorporated by reference.

### TECHNICAL FIELD

The present disclosure relates to the field of optoelectronic technology, and in particular to a laser-ranging device and a laser-ranging telescope.

### DESCRIPTION OF THE PRIOR ART

The telescope is an important viewing tool. Especially, it is further equipped with a ranging function after the introduction of laser-ranging technology, greatly expanding its application field. Currently, the laser-ranging component of a laser-ranging telescope is typically installed within the barrel. This means that the laser-transmitting optical path and laser-receiving optical path are mixed with the observation optical path, making it difficult to adjust the laser-ranging component and the telescope separately. Furthermore, the laser-ranging component of the telescope typically takes up a considerable amount of space within the barrel, rendering the telescope cumbersome to use and carry around.

### SUMMARY OF THE DISCLOSURE

In view of this, an objective of the present disclosure is to provide a laser-ranging device and a laser-ranging telescope, so as to address or at least to some extent mitigate the above problems.

The present disclosure provides a laser-ranging device being attachable to a complete telescope as an independent component, the telescope including first and second telescope bodies, the laser-ranging device including first and second barrels deposed in front of objective lenses of the first and second telescope bodies, respectively; wherein interior of the first barrel is provided with a laser transmitter for emitting laser, a first concave mirror for reflecting the laser, and a first dichroic mirror for reflecting the laser and transmitting natural light; and interior of the second barrel is provided with a laser receiver for receiving the laser, a second concave mirror for reflecting the laser, and a second dichroic mirror for reflecting the laser and transmitting the natural light; wherein central axes of the first and second barrels align with those of the first and second telescope bodies, respectively; and the laser emitted by the laser transmitter is then successively reflected by the first concave mirror and the first dichroic mirror before being directed towards a target object, and the laser reflected by the target object is then successively reflected by the second dichroic mirror and the second concave mirror before being received by the laser receiver, thereby measuring distance between the target object and the laser-ranging device.

In some embodiments, a first coupling lens for converging the laser is installed at a transmitting end of the laser transmitter.

In some embodiments, a second coupling lens for converging the laser is installed at a receiving end of the laser receiver.

In some embodiments, the laser transmitter and the first concave mirror are arranged opposite each other on a side wall of the first barrel with a reflection surface of the first concave mirror facing the laser transmitter.

In some embodiments, the laser receiver and the second concave mirror are arranged opposite each other on a side wall of the second barrel with a reflection surface of the second concave mirror facing the laser receiver.

In some embodiments, opposing ends of the first dichroic mirror are in contact with the laser transmitter and the first concave mirror, respectively.

In some embodiments, a reflective surface of the first dichroic mirror is inclined relative to central axis of the first barrel.

In some embodiments, opposing ends of the second dichroic mirror are in contact with the laser receiver and the second concave mirror, respectively.

In some embodiments, wherein a reflective surface of the second dichroic mirror is inclined relative to central axis of the second barrel.

In some embodiments, wherein the reflective surface of the first dichroic mirror faces the first concave mirror and the laser transmitter.

In some embodiments, the reflective surface of the second dichroic mirror faces the second concave reflective mirror and the laser receiver.

In some embodiments, the laser transmitter is located at an end of the first barrel away from the corresponding objective lens.

In some embodiments, the laser receiver is located at an end of the second barrel away from a corresponding objective lens.

In some embodiments, the opposing ends of the first dichroic mirror are in contact with a bottom end of the laser transmitter and a bottom end of the first concave mirror, respectively.

In some embodiments, the opposing ends of the second dichroic mirror are in contact with a bottom end of the laser receiver and a bottom end of the second concave mirror, respectively.

In some embodiments, a shape and size of the first and second lenses are identical.

In some embodiments, the first and second dichroic mirrors are both narrow-band coated.

In some embodiments, the first and second barrels are separately arranged.

In some embodiments, wherein a length of the first concave mirror is greater than that of the laser transmitter, and a length of the second concave mirror is greater than that of the laser transmitter above.

The disclosure further provides a laser-ranging telescope including the laser-ranging device, wherein the laser-ranging device is arranged in front of the objective lenses of the telescope.

Compared with the prior art, the laser-ranging device according to embodiments of the present disclosure is attachable to different telescopes as an independent component, which improves its versatility and adaptability. Furthermore, since the laser-ranging device is arranged in front of the objective lenses of the telescope, the laser-ranging optical path and the observation optical path are independent of each other. Therefore, the adjustments of the laser-ranging device and the telescope are also independent of each other. Moreover, the use of concave mirrors reduces the space occupied by the flying optical path, thereby minimizing the required volume of the barrel.

### BRIEF DESCRIPTION OF DRAWINGS

FIG. 1 is a perspective view of a laser-ranging telescope according to an embodiment of the present disclosure.

FIG. 2 is a cross-sectional view of the laser-ranging telescope in FIG. 1, in which a laser-ranging optical path is shown.

FIG. 3 is an exploded view of the laser-ranging telescope in FIG. 1.

List of Reference signs:
100. laser-ranging telescope; 10. laser-ranging device; 11. first barrel; 12. second barrel; 111. laser transmitter; 112. first concave mirror; 122. second concave mirror; 113. first dichroic mirror; 123. second dichroic mirror; 121. laser receiver; 114. first coupling lens; 124. second coupling lens; 115. first mounting seat; 1151. first mounting hole; 1152. second mounting hole; 1153. third mounting hole; 1154. fourth mounting hole; 125. second mounting seat; 1251. fifth mounting hole; 1252. sixth mounting hole; 1253. seventh mounting hole; 1254. eighth mounting hole; 116. first protective lens; 126. second protective lens; 20. telescope; 21. first telescope body; 22. second telescope body; 23. objective lens.

### DESCRIPTION OF EMBODIMENTS

The technical solutions of the embodiments of the present disclosure are described clearly and completely in detail below in combination with the accompanying drawings. Evidently, the embodiments described are merely a portion of the embodiments of the present disclosure, but not all of the embodiments. Based on the embodiments of the present disclosure, all other embodiments, which are obtained by those skilled in the art without creative work, fall within the protection scope of the present disclosure.

It should be noted that when a component is referred to as being “connected” to another component, it may be directly connected to another component, or there may also be a component arranged intermediately. When a component is considered to be “provided/arranged” on another component, it may be directly provided/arranged on another component or there may also be a component arranged intermediately.

Unless otherwise defined, all technical and scientific terms used herein have the same meaning as commonly understood by those skilled in the art of the present disclosure. The terms used herein in the specification of the present disclosure are only for illustration of specific embodiments, and are not intended to limit the present disclosure.

It is also to be noted that orientation terms such as left, right, top and bottom in the embodiments are only a relative concept to each other, or referred to by taking a normal use state of a product as reference, and should not be regarded as limitation.

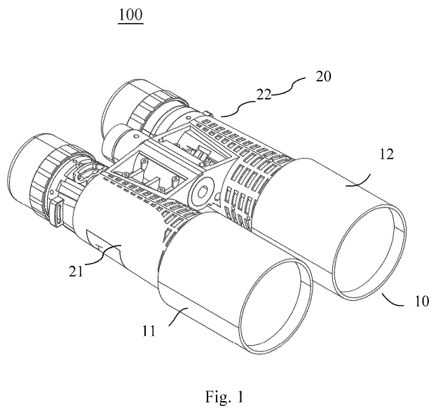

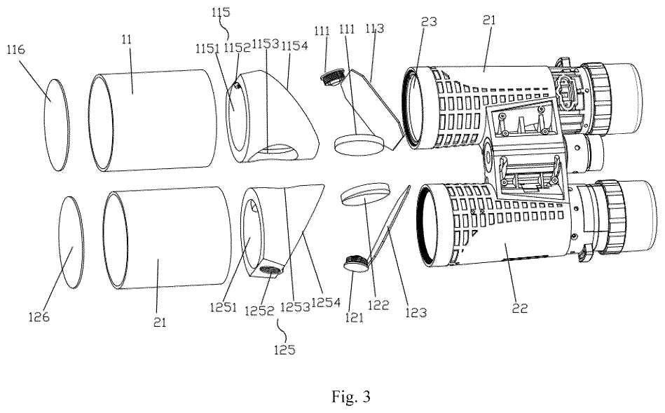

As shown in FIGS. 1-3, a laser-ranging telescope 100 according to an embodiment of the present disclosure includes a telescope 20 and a laser-ranging device 10 arranged in front of the telescope 20. The telescope 20, which is equipped with objective lenses and eyepieces, is a complete telescope capable of performing observation duties on its own. The laser-ranging device 10 is attachable to the telescope 20 as an independent component. For example, the laser-ranging device 10 may be attached to the telescope 20 through a screw connection, snap connection, buckle connection, etc. Therefore, the laser-ranging device 10 is adaptable to different telescopes, thereby improving its versatility and adaptability. In addition, the introduction of the laser-ranging device 10 has equipped the telescope 20 with a ranging function, without compromising the normal observational function.

The telescope 20 includes a first telescope body 21 and a second telescope body 22 with identical structures. The first and second telescope bodies 21, 22 extend in an axial direction, respectively, and each has an objective lens and an eyepiece arranged at its opposing axial ends. The axial direction and radial direction thereafter refer to the axial direction and radial direction of the telescope 100. When it is in use, the objective lens 23 is positioned near a target object being observed, while the eyepiece is positioned near eyes of an observer.

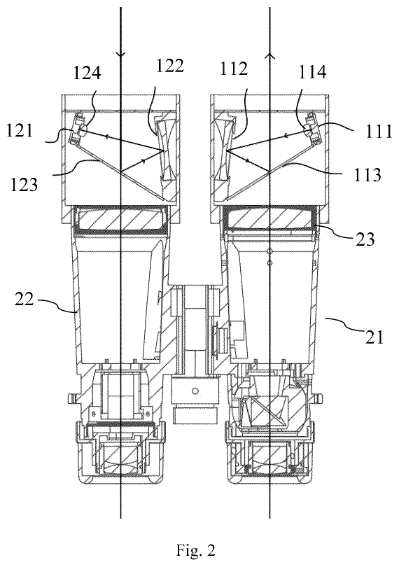

Referring to FIG. 2, the laser-ranging device 10, installed in front of the objective lenses 23 of the telescope 20, includes a first barrel 11, a second barrel 12 and a first mounting seat 115 and a second mounting seat 125 respectively located inside the first barrel and second barrels 11, 12. The first mounting seat 115 is equipped with a laser transmitter 111 for emitting a laser, a first concave mirror for converging and reflecting the laser and a first dichroic mirror for reflecting the laser and transmitting natural light. The second mounting seat 116 is equipped with a second concave mirror for converging and reflecting the laser, a second dichroic mirror for reflecting the laser and transmitting natural light, and a laser receiver 121 for receiving the laser.

Specially, as shown in FIGS. 1 and 4, the first mounting seat 115 is in an irregular cylindrical shape, with a first mounting hole 1151 and a fourth mounting hole 1154 defined at both axial ends for installing the first protective lens 116 and the first dichroic mirror 113, respectively. Opposite side walls of the first mounting seat 115 define a second mounting hole 1252 and a third mounting hole 1253 for mounting the laser transmitter 111 and the first concave mirror 113, respectively. Similarly, the second mounting seat 125 also has an irregular cylindrical shape, with a fifth mounting hole 1251 and a sixth mounting hole 1254 defined at both axial ends for installing the second protective lens 125 and the second dichroic mirror, respectively. Opposite side walls of the second mounting seat 125 define the seventh mounting hole 1253 and the eighth mounting hole 1254, respectively, for installing the laser receiver 121 and the second concave mirror 123. It could be understood that sizes and configurations of the installation holes are adaptable to the corresponding components. Preferably, the laser transmitter 111 and laser receiver 121 are located on side walls of the first and second barrels 11, 12 facing away from each other, respectively. The laser transmitter 111, first concave mirror 112, and the first dichroic mirror 113 are accommodated within the space cooperatively defined by the first barrel 11, the first protective lens 116, and the objective lens 23. The laser receiver 121, the second concave mirror 122, and second dichroic mirror 123 are accommodated within the space cooperatively defined by the second barrel 12, the second protective lens 126, and the objective lens 23. This helps to enhance sealing of the laser-ranging device 10.

The laser emitted by the laser transmitter 123 is successively reflected by the first concave mirror 112 and the first dichroic mirror 113 before being directed towards the target object, forming a laser emission optical path. The laser reflected by the target object is successively reflected by the second dichroic mirror 123 and the second concave mirror 122 before being finally received by the laser receiver 112, forming a laser-receiving optical path. The laser-transmitting optical path and the laser-receiving optical path together form a laser-ranging optical path. For the principle of laser ranging, please refer to the prior art which is not described in detail here. The natural light reflected by the target object passes through the dichroic mirror of the barrel 11, then enters the telescope 20, forming a natural optical path. It could be understood that the natural optical path passing through the first telescope body 21 is similar to that passing through the second telescope body 22.

Specifically, the first and second barrels 11, 12 are both in hollow tube shapes with identical size, and are connected to front ends of the first and second telescope bodies 21, 22, respectively. In this embodiment, central axes of the first and second barrels 11, 12 align with those of the first and second telescope bodies 21, 22, respectively. This ensures that the center of the laser-ranging optical path coincides with that of the natural optical path, guaranteeing that the distance measured is the distance between the target object and the laser-ranging telescope 100. Preferably, radial dimension of the first and second barrels 11, 12 may be slightly larger than that of the corresponding telescope body. It could be understood that in other embodiments, outer peripheral surfaces of the first and second barrels 11, 12 may extend axially along corresponding outer peripheral surfaces of the first and second telescope bodies 21, 22, forming a smooth connection between the barrel and the telescope body 20. The first barrel 11 may be arranged separately from the second barrel 12, alternatively, it may also be formed as one single piece with the second barrel 12.

Referring to FIG. 2, the laser transmitter 111 and the first concave mirror 112 are disposed opposite each other on a side wall of the first barrel 11. A transmitting end of the laser transmitter 111 faces the first concave mirror 112, and the laser transmitter 111 is located at an end of the first barrel 11 away from the objective lens. A reflective surface of the first concave mirror 112 faces the laser transmitter 111. The first concave mirror 112 has a concave reflective surface configured to converge and reflect the laser emitted by the laser transmitter 111. Preferably, the first concave mirror 112 occupies a majority portion of first barrel 11 in the axial direction. In this embodiment, opposing axial ends of the first concave mirror 112 are located at the opposing axial ends of the first barrel 11, respectively. The reflective surface of the first concave mirror 112 is slightly inclined relative to the central axis of the first barrel 11.

The first dichroic mirror 113 is configured to reflect the laser reflected by the first concave mirror 112 and transmit the natural light emitted through the first telescope body 22. Opposing ends of the first dichroic mirror 113 are in contact with bottom ends of the laser transmitter 111 and the first dichroic mirror 113, respectively. The first dichroic mirror 113 is in a flat plate shape, with the reflective surface facing the target object, the first concave mirror 112, and the laser transmitter 111. Preferably, the reflective surface of the first dichroic mirror 113 of this embodiment is inclined with respect to the central axis of the first barrel 11. This allows the laser, emitted from the laser transmitter 111 and successively reflected by the first concave mirror 112 and the first dichroic mirror 113, to exit the first barrel 11 along the axial direction and reach the target object.

Similarly, the laser receiver 112 and the second concave mirror 122 are disposed opposite each other on a side wall of the first barrel 112. The laser receiver 112 is configured to receive the laser reflected by the second concave mirror 122, with its receiving end facing the second concave mirror 122. The laser receiver 112 is located at an end of the second barrel 12 away from the corresponding objective lens. The reflective surface of the second concave mirror 122 faces the laser receiver 112. The second concave mirror 122 has a concave reflecting surface configured to converge and reflect the laser reflected by the second dichroic mirror 123. Preferably, the second concave mirror 122 occupies a majority portion of the second barrel 12 in the axial direction. Opposing axial ends of the second concave mirror 122 are located at the opposing axial ends of the second barrel 12, respectively. The reflecting surface of the second concave mirror 122 is slightly inclined relative to the central axis of the second barrel 12.

The second dichroic mirror 123 is configured to reflect the laser reflected by the target object and transmit the natural light entering into the first barrel 11. Opposing ends of the second dichroic mirror 123 are in contact with bottom ends of the laser receiver 112 and the second concave mirror 122, respectively, with its reflective surface facing the target object, the second concave mirror 122, and laser receiver 112. The reflecting surface of the second dichroic mirror 123 is inclined relative to the central axis of the second barrel 12. The laser reflected by the target object enters the second barrel 12, and is successively reflected by the second dichroic mirror 123 and the second concave mirror 122 before finally being received by the laser receiver 112. In this embodiment, a data display screen, for instance, may be provided at a specific focus of the eyepiece of the telescope body 20. The data display screen is connected to the laser receiver 112, allowing a ranging center and ranging data to be displayed within the user's eyes along with the observation image.

In general, an optical path that does not pass through a lens and is merely transmitted in the air is referred to as a flying optical path, which occupies a significant amount of space within the observation device. In this embodiment, the configuration of the concave mirror helps to reduce the amount of optical path transmitted in the air, thereby minimizing the space required for the flying optical path.

Preferably, the transmitting end of the laser transmitter 111 of this embodiment is equipped with a first coupling lens 114 for converging the laser. Similarly, the receiving end of the laser receiver 112 is equipped with a second coupling lens 124 for converging the laser. Preferably, the first and second dichroic mirrors 1231,1232 are both narrow-band coated, which can reflect the laser of a specific wavelength band, such as less than 400 nm or greater than 800 nm while allowing the transmission of natural light.

The laser-ranging device 10 according to embodiments of the present disclosure is attachable to the telescope 20 as an independent component, this allows the laser-ranging device 10 to be easily integrated with various telescopes, greatly enhancing its versatility and adaptability. Moreover, since the laser-ranging device 10 is located in front of the objective lens of the telescope 20, the laser-ranging device 10 and the telescope 20 do not share a common optical element therebetween, and the laser-ranging optical path and the observation optical path are independent of each other. Therefore, the adjustment of the laser-ranging device and the telescope are also independent of each other, enhancing user convenience. In addition, the laser-ranging device 10 uses the concave mirror to converge and reflect the laser, with the concave mirror 122, the dichroic mirror 123, the laser transmitter 111, and the laser receiver 112 arranged within the barrel in an innovative configuration, which minimizes the space occupied by the flight optical path and, thereby reducing the required volume of the barrel.

The above are only preferred embodiments of the present invention, and the protection scope of the present invention is not limited to the above-listed examples. Any person skilled in the art can obviously obtain the technology within the technical scope disclosed in the present invention. Simple changes or equivalent replacements of the solutions fall within the protection scope of the present invention.

1. A laser-ranging device being attachable to a complete telescope as an independent component, the telescope comprising first and second telescope bodies, the laser-ranging device comprising:
first and second barrels arranged in front of objective lenses of the first and second telescope bodies, respectively;
wherein an interior of the first barrel is provided with a laser transmitter for emitting laser, a first concave mirror for converging and reflecting the laser, and a first dichroic mirror for reflecting the laser and transmitting natural light; and
an interior of the second barrel is provided with a laser receiver for receiving the laser, a second concave mirror for converging and reflecting the laser, and a second dichroic mirror for reflecting the laser and transmitting the natural light;
wherein central axes of the first and second barrels align with central axes of the first and second telescope bodies, respectively; and
the laser emitted by the laser transmitter is successively reflected by the first concave mirror and the first dichroic mirror before being directed towards a target object, the laser reflected by the target object is then successively reflected by the second dichroic mirror and the second concave mirror before being finally received by the laser receiver, and distance between the target object and the laser-ranging device is thereby measured.

2. The laser-ranging device according to claim 1, wherein a first coupling lens for converging the laser is installed at a transmitting end of the laser transmitter.

3. The laser-ranging device according to claim 1, wherein a second coupling lens for converging the laser is installed at a receiving end of the laser receiver.

4. The laser-ranging device according to claim 1, wherein the laser transmitter and the first concave mirror are arranged opposite each other on a side wall of the first barrel, with a reflection surface of the first concave mirror facing the laser transmitter.

5. The laser-ranging device according to claim 1, wherein the laser receiver and the second concave mirror are arranged opposite each other on a side wall of the second barrel, with a reflection surface of the second concave mirror facing the laser receiver.

6. The laser-ranging device according to claim 1, wherein opposing ends of the first dichroic mirror are in contact with the laser transmitter and the first concave mirror, respectively.

7. The laser-ranging device according to claim 1, wherein a reflective surface of the first dichroic mirror is inclined relative to central axis of the first barrel.

8. The laser-ranging device according to claim 1, wherein opposing ends of the second dichroic mirror are in contact with the laser receiver and the second concave mirror, respectively.

9. The laser-ranging device according to claim 1, wherein a reflective surface of the second dichroic mirror is inclined relative to central axis of the second barrel.

10. The laser-ranging device according to claim 7, wherein the reflective surface of the first dichroic mirror faces the first concave mirror and the laser transmitter.

11. The laser-ranging device according to claim 9, wherein the reflective surface of the second dichroic mirror faces the second concave reflective mirror and the laser receiver.

12. The laser-ranging device according to claim 1, wherein the laser transmitter is located at an end of the first barrel away from a corresponding objective lens.

13. The laser-ranging device according to claim 1, wherein the laser receiver is located at an end of the second barrel away from a corresponding objective lens.

14. The laser-ranging device according to claim 6, wherein the opposing ends of the first dichroic mirror are in contact with bottom ends of the laser transmitter and the first concave mirror, respectively.

15. The laser-ranging device according to claim 8, wherein the opposing ends of the second dichroic mirror are in contact with bottom ends of the laser receiver and the second concave mirror, respectively.

16. The laser-ranging device according to claim 1, wherein a shape and size of the first barrel are identical to those of the second barrel.

17. The laser-ranging device according to claim 1, wherein the first and second dichroic mirrors are both narrow-band coated.

18. The laser-ranging device according to claim 1, wherein the first and second barrels are separately arranged.

19. The laser-ranging device according to claim 1, wherein a length of the first concave mirror is greater than that of the laser transmitter, and a length of the second concave mirror is greater than that of the laser transmitter.

20. A laser-ranging telescope comprising the laser-ranging device according to claim 1, wherein the laser-ranging device is arranged in front of the objective lenses of the telescope.
